(19) United States
(12) Patent Application Publication
(10) Pub. No.: US 2026/0163262 A1
(43) Pub. Date: Jun. 11, 2026

(54) HARDLINE TAP WITH EXTENDED FREQUENCY FEATURES

(71) Applicant: Holland Electronics LLC, Ventura, CA (US)

(72) Inventors: George Goebel, Camarillo, CA (US); Ron Hui Li, Brooklyn, NY (US); Brian J. Shapson, Jackson, NJ (US); Haiqun Hong, Shangrao City (CN); Robert L. Romerein, Peterborough (CA)

(21) Appl. No.: 19/415,101

(22) Filed: Dec. 10, 2025

Related U.S. Application Data
(60) Provisional application No. 63/730,851, filed on Dec. 11, 2024.

(51) Int. Cl. H01R 9/05

(52) U.S. Cl. CPC H01R 9/05

(57) ABSTRACT

A hardline tap includes a metallic tap housing, internal tap electronics, hardline coaxial cable sockets, and may employ, among other things, any of impedance matching, connections of reduced size, and specialty inductors to extend its application to signal distribution systems operating at more than one gigahertz.

### BENEFIT CLAIM

This application claims the benefit of U.S. Prov. Patent App. No. 63/730,851 filed Dec. 11, 2024 and entitled Hardline Tap With Extended Frequency Features.

### INCORPORATION BY REFERENCE

This application incorporates by reference in its entirety and for all purposes the disclosure of U.S. Patent App. No. 63/633,717 filed Apr. 13, 2024.

### BACKGROUND OF THE INVENTION

### Field of the Invention

The present invention relates to signal distribution equipment including signal distribution equipment for cable television. In particular, the invention relates to hardline taps and hardline taps with extended frequency features.

### Discussion of the Related Art

A signal distribution system may include signal conditioning devices that pass, separate, or combine electrical signals such as power signals and radio frequency signals.

For example, signal distribution may employ signal conditioning devices connected by a coaxial cable for transporting both the RF signal spectrum and the AC power spectrum. In some known devices, these two spectra are separated or recombined upon device entry and recombined upon device exit by a capacitor and an inductor operable at frequencies of up to about 1 GHz.

### SUMMARY OF THE INVENTION

Embodiments of the invention relate to electrical and electronic devices such as devices that involve impedances, contactors, and inductors. In particular, the invention relates to components, devices, and/or circuits that separate and/or combine power, wideband, and ultrawideband radio frequency signals using, among other things, power routing inductors suited for ultrawideband service. Ultrawideband RF signals refers to RF signals which may reach about: 1 GHz or more; 1.5 GHz or more; 1.8. GHz or more; 2.0 GHz or more; or 2.5 GHz or more.

In an embodiment, a cable television tap with extended frequency features comprises: a metallic tap housing with internal tap electronics; the housing having upstream and downstream sockets for receiving stingers of respective upstream and downstream coaxial cable connectors that terminate upstream and downstream hardline coaxial cables; a first of the sockets having a circular inner passage adjoining a circular outer passage; and, a first of the stingers inserted through the centers of the passages and thereafter through the cage of a seizing pin; wherein the first stinger passes coaxially through the inner passage with an impedance that is within 30% of the impedance of one of the hardline coaxial cables.

In an embodiment, a cable television tap with extended frequency features comprising: a metallic tap housing with internal tap electronics; the housing having upstream and downstream sockets for receiving stingers of respective upstream and downstream coaxial cable connectors that terminate upstream and downstream hardline coaxial cables; a first of the sockets having a circular inner passage adjoining a circular outer passage; a first of the stingers inserted through the centers of the passages and thereafter through a hole in a seizing pin cage; and, the stinger pressed against an upper roof of the caged ball that is below the stinger; wherein the ball is urged toward the cage roof by a compression spring that is a flattened open loop spring, the opening in the loop bearing on the ball.

In an embodiment, a cable television tap with extended frequency features comprises: a metallic tap housing with internal tap electronics; the housing having upstream and downstream sockets for receiving stingers of respective upstream and downstream coaxial cable connectors that terminate upstream and downstream hardline coaxial cables; an inductor including wire encircling a magnetic core such that there are at least 1^{st}, 2^{nd}, and 3^{rd} regions of windings, the 2^{nd} region being between the 1^{st} and 3^{rd} regions; the inductor interconnecting center conductors of the upstream and downstream hardline coaxial cables; and, electrically resistive collar or collars that do not interconnect with the windings encircling the inductor near a boundary between a 1^{st} and 2^{nd} winding and near a boundary between a 2^{nd} and 3^{rd} winding; and, wherein the collars dampen electromagnetic fields created when RF resonance occurs across the inductor.

### BRIEF DESCRIPTION OF THE DRAWINGS

The present invention is described with reference to the accompanying figures. These figures, incorporated herein and forming part of the specification, illustrate embodiments of the invention and, together with the description, serve to further explain its principles enabling a person skilled in the relevant art to make and use the invention. The invention may include all or less than all of the features illustrated.

FIG. 1 shows cable television distribution system including taps 1 and 2.

FIG. 2 shows a block diagram of a tap such as the tap of FIG. 1.

FIGS. 3A-C show facsimiles of a two port tap in accordance with FIG. 2.

FIGS. 3D-E show coaxial cable and a male hardline coaxial cable connector.

FIGS. 4A-B show cross-sectional drawings of a tap and of tap internal parts.

FIGS. 4C-D show a tap seizing pin assembly.

FIG. 4E shows alternate mating of hardline connectors with a seizing pin.

FIG. 5A shows a schematic drawing of a tap with internal inductor and tap electronics.

FIGS. 5B-D show inductors for use with selected taps.

### DETAILED DESCRIPTION OF PREFERRED EMBODIMENTS

Unless otherwise determined by context, connections, attachments, and the like mentioned herein may be direct or indirect. That is, connecting parts or electrical connections need not be direct from A to B, but may include intervening part(s) such that the connection is indirect.

### Tap Use in a Distribution System

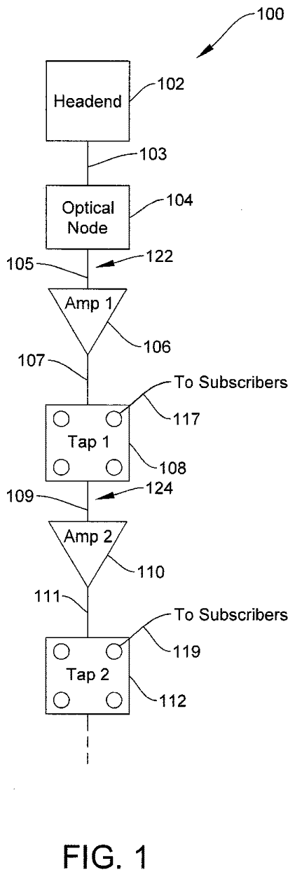

FIG. 1 shows a signal distribution system 100 such as a cable television distribution system utilizing a headend 102 connected 103 to an optical node 104. Signals traverse a trunkline 105, 107, 109, 111 such as coaxial hardline that interconnects with the optical node 104. Moving away from the optical node, the trunkline may interconnect with any of amplifiers 106, 110, taps and/or hardline taps 108, 112 and other active or passive devices. In some embodiments, taps interconnect with coaxial cable subscriber lines such as 117, 119 which may be flexible coaxial cable. In some embodiments RF signals may originate at the headend and equipment supply voltage signals may originate at various locations, e.g. 122, 124, along the coaxial cables.

### Tap Nomenclature

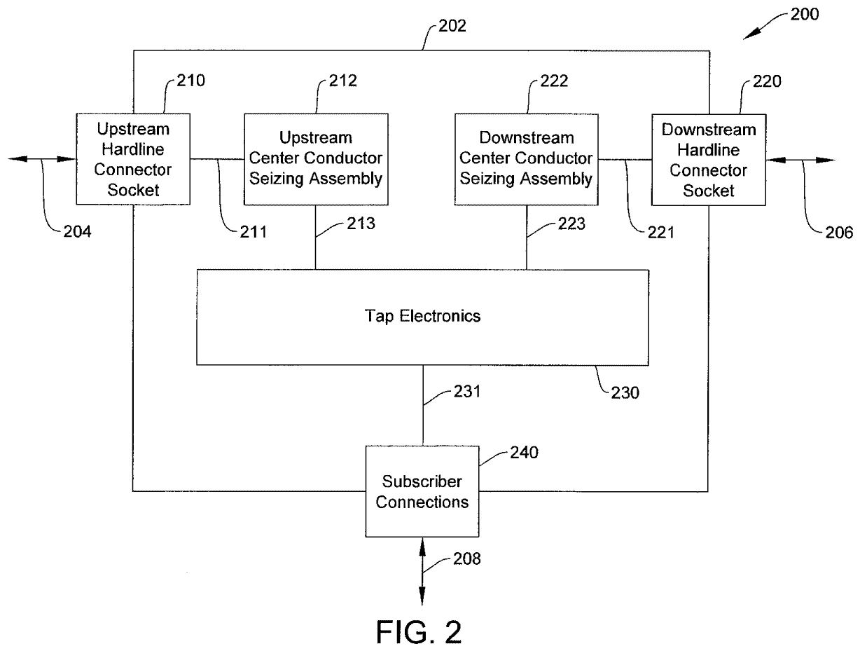

Various embodiments employ selected ones of the tap nomenclature features described below. FIG. 2 shows a schematic diagram of a tap such as a hardline tap with extended frequency features 200. Here, a tap housing 202 such as a metallic housing interfaces with coaxial hardlines and subscriber connections. Upstream and downstream coaxial hardlines may convey power signals and bidirectional Radio Frequency (RF) signals 204, 206. Note that hardlines refers to coaxial cables. Hardlines includes hardline coaxial cables and other coaxial cables suitable for the intended application, for example a flexible coaxial cable that may be used in the application above in place of a hardline.

Subscriber connections 208 may convey bidirectional Radio Frequency signals. Exemplary hardline cables may include P3 from CommScope, QR from CommScope, TX from Digicomm International, and MC2 from Digicomm International. Exemplary subscriber connection coaxial cables may include RG6 and RG11.

As seen, an upstream hardline connector socket 210 provides a connection to the upstream hardline cable and a downstream hardline connector socket 220 provides a connection to the downstream hardline cable. A conductor 211 interconnects the socket 210 to an upstream center conductor seizing assembly 212. And, a conductor 221 interconnects the socket 220 to an upstream center conductor seizing assembly 222. As will be known to skilled artisans, connections conveying signals from and among coaxial cables are electrical connections.

Hardline signals are exchanged with tap electronics 230 via a conductor 213 connecting with the upstream seizing assembly 212 and via a conductor 223 connecting with the downstream seizing assembly 222. Subscriber signals are exchanged with tap electronics 230 via a conductor 231 connecting with the subscriber connections 240.

As disclosed in U.S. Pat. App. No. 63/633,717, tap electronics may include components, devices, and/or circuits that separate and/or combine power and ultrawideband radio frequency signals using, among other things, power routing inductors suited for ultrawideband service. In various embodiments, ultrawideband RF signals refers to RF signals which may reach about: 1 GHz or more; 1.5 GHz or more; 1.8. GHz or more; 2.0 GHz or more; or 2.5 GHz or more.

### Exemplary Two Port Tap

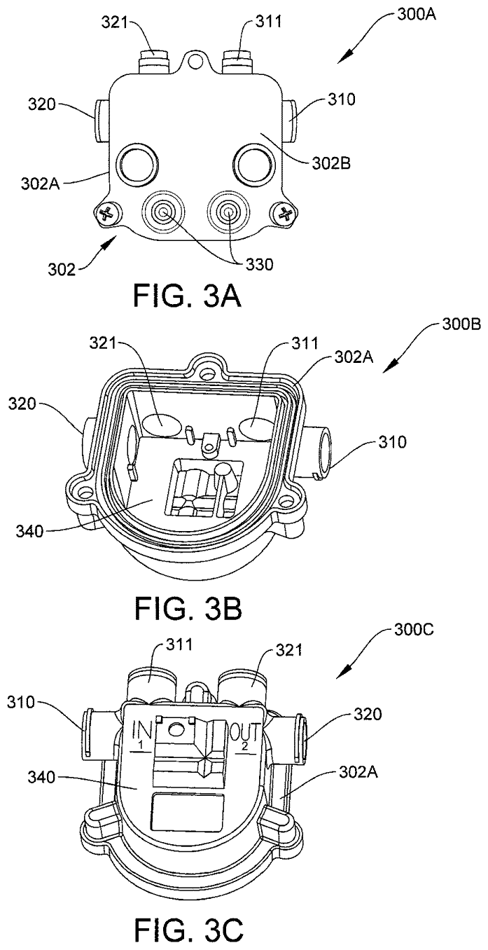

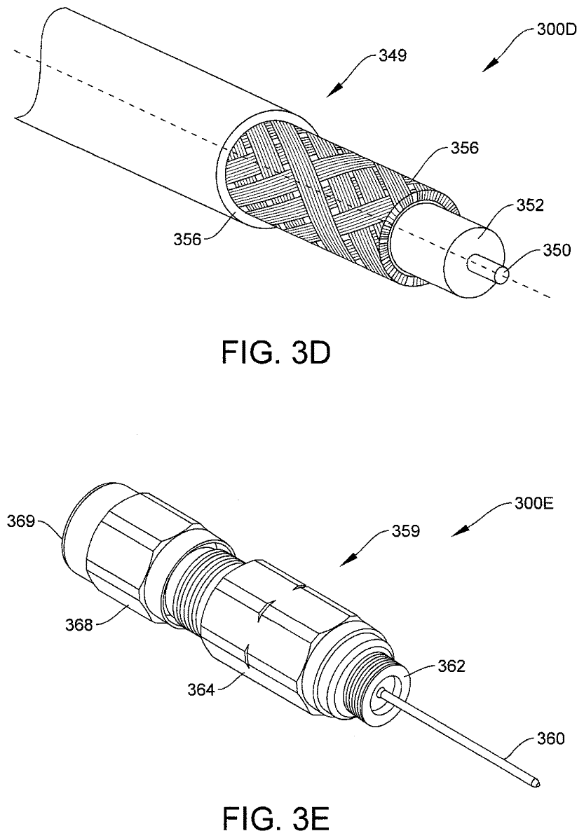

Various embodiments employ selected ones of the tap exemplary two port tap features described below. FIG. 3A shows an exemplary tap housing 300A. The housing 302 includes a lower bowl 302A and an upper lid 302B. The upper lid 302B incorporates subscriber connections 330. The lower bowl 302A incorporates a) interconnected/alternate upstream hardline connector sockets 320, 321 and b) interconnected/alternate downstream hardline connector sockets 310, 311. Notably, in some embodiments the placement of upstream and downstream sockets may be reversed.

FIG. 3B shows an upturned exemplary lower tap housing 300B. Hardline connector sockets 320, 321 and 310,311 are in the housing sidewalls which extend from a tap hosing floor 340. Hardline connector sockets 320, 321 are alternates (only one used depending upon hardline approach) situated at a right angle and will as shown below utilize the same seizing pin (a first seizing pin). Further, hardline connector sockets 310, 311 are alternates situated at a right angle and will as shown below utilize the same seizing pin (a second seizing pin).

FIG. 3C shows a downturned exemplary lower tap housing 300C. In this view the tap housing floor 340 is situated at the top of the housing 302A.

FIG. 3D shows a hardline coaxial cable or a substitute for such a cable 300D. The cable 349 includes a center conductor 350, a dielectric 352 surrounding the center conductor, a conductive outer sheath 356 such as a braided sheath, and a jacket 356. ANSI/SCTE 15 2022, Section 11.2 at page 13 provides examples of hardline coaxial cables. Typical cables have outer diameters ranging from 0.625 inch to 0.875 inch, such as HL series cables.

FIG. 3E shows a hardline coaxial connector with stinger 300E. The connector 359 includes a central stinger 360 protruding from a connecting end 362. The connecting end and a forward body 364 are for attachment such as screwed attachment to a compression piece 368. Opposite the connecting end is a coaxial cable entry end 369 which receives a coaxial cable. When a cable is inserted through the compression piece and into the forward body, the cable center conductor engages the stinger. Thereafter, the compression piece is used to fix the cable to the connector.

The above illustrates an exemplary tap housing having, for instance, two subscriber connections. However, the number of subscriber connections, the electronics to support subscriber connections, and the shape/size of the housing may vary while still benefitting from the disclosure of this application. For example, taps with 8 subscriber connections in a rectangular housing may nevertheless utilize the disclosure herein.

### Tap Hardline Interface

Various embodiments employ selected ones of the tap hardline interface features described below.

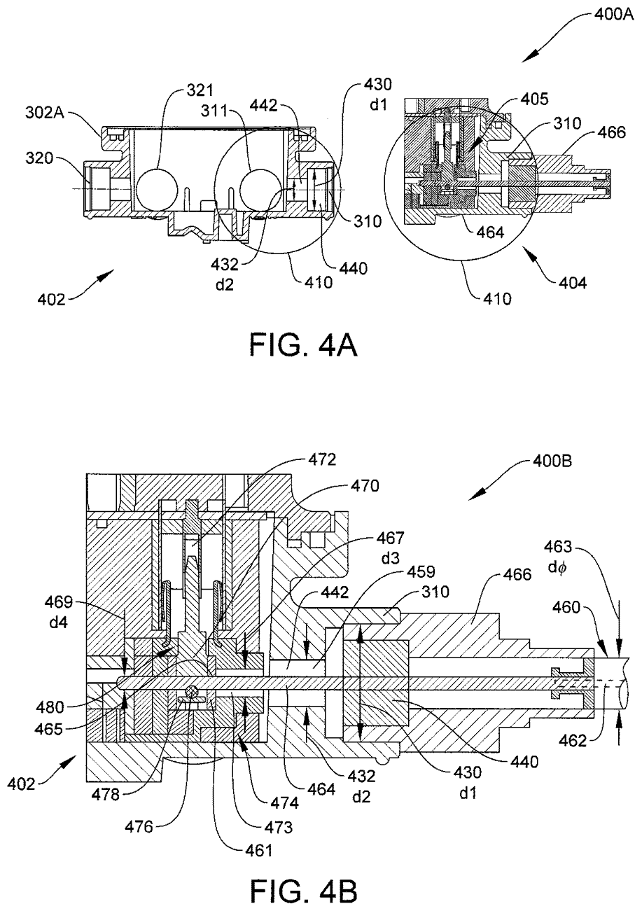

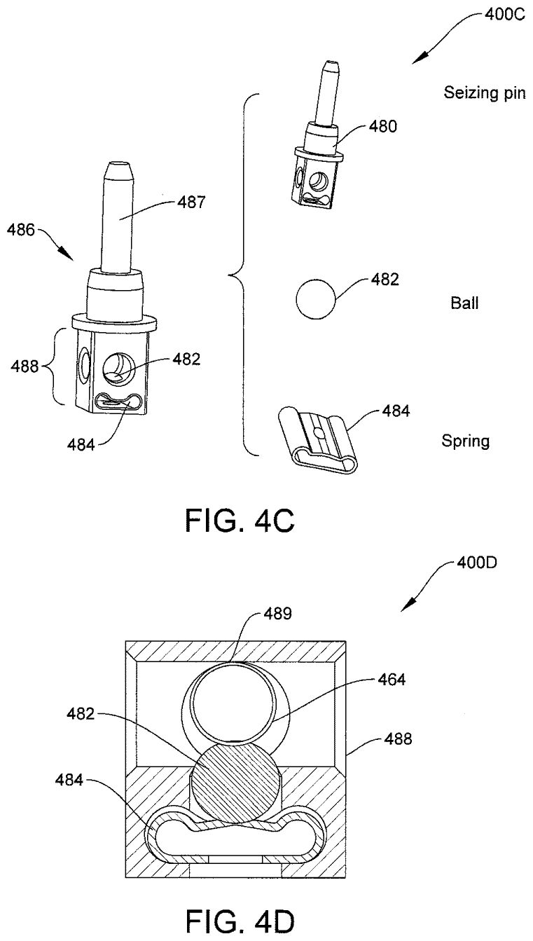

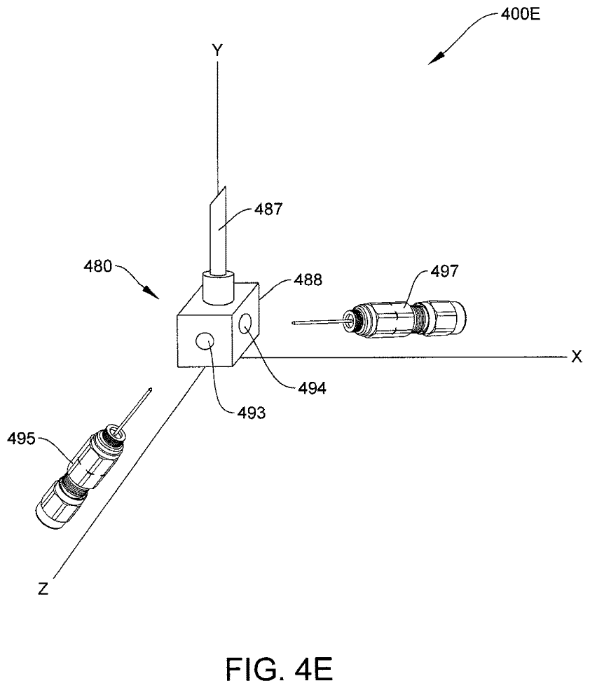

FIG. 4A shows cross-sectional views of the lower tap housing 400A. The housing views show a) a cross section through a complete lower housing 402 and b) a cross section through a housing portion 404. Similar portions of the two views are indicated by the circle 410.

FIGS. 4A-B show details of the lower tap housing with internal parts 400A-B. The complete housing view 402 shows hardline connector sockets 320, 321 and 310, 311. Hardline connector socket 310 is shown in both of the views and selected dimensions are indicated in the complete housing view at left. Here, hardline connecctor socket diameter 430 is d1, an outer passage 442 has diameter d2, and an inner passage 473 has diameter d3. In some embodiments the inner and outer passages may adjoin.

Housing portion cross-section 404 includes an interconnected coaxial connector 466 and tap internal parts 405 for connecting to a stinger 464 of the coaxial connector.

An insulating body or bodies 474 is adjacent to or abuts outer passage 442. The insulating body receives the seizing pin cage 488 and provides inner passage 473 through which the stinger passes. In some embodiments, a shielding member 461 receives the stinger 464 between the inner passage d3 and the seizing pin 480, the stinger passing through a shielding member aperture 465. In some embodiments the aperture may have a diameter 0.5 to 10.0 percent larger than the stinger diameter. In some embodiments, the shielding member substantially attenuates radio frequency (RF) signals passing therethrough, for example passing through a space between the stinger and the hole in the shield by 50% to 90% or more. A similar shielding member may be located between the inner and outer passages.

A hardline coaxial cable 460 having diameter 463/d0 is attached to a coaxial connector 466. The cable has a center conductor 462 and its outer diameter 463 is d0. The stinger 464 which is centrally located in the coaxial connector electrically interconnects the hardline coaxial cable center conductor 350 and seizing pin 470. The stinger diameter 469 is d4.

In an embodiment the seizing pin 470 has a rod-like extension atop a multi-sided base with through holes for receiving the stinger. The seizing pin or its rod line extension interconnects with tap electronics via a tap terminal 472. In this manner a circuit is completed between the hardline coaxial cable center conductor 462 and tap electronics 230.

In some embodiments the seizing pin 470 is a part of an assembly that includes a biasing member such as a spring or compression spring 478 that presses a contactor 476 against a stinger that passes through a hole 482 in the seizing pin.

Extended frequency features of the tap hardline interface include various relationships including geometric relationships. In some embodiments, a first feature is the relationship between d0 and d2; in various embodiments, diameter d2 is 70 to 85 percent of diameter d0.

In some embodiments, a second feature is the relationship between d1 and d2; in various embodiments, diameter d2 is less than half of diameter d1.

In some embodiments, a third feature is the impedance of the 75 ohm coaxial cable 460 matching within 10% or 20% or 25 % or 30% or 40% the impedance of the stinger 464 with diameter d4 passing through the center of passageway 459 with diameter d2.

In some embodiments, a fourth feature is the impedance of the 75 Ohm coaxial cable 460 matching within 10% or 20% or 25% or 30% or 40% the impedance of the stinger with diameter d4 passing through the center of one or more passageways between the seizing pin 470 and the coaxial connector 466.

In some embodiments, impedance matching of the 75 ohm coaxial cable 460 to impedances of stinger 464 regions adjacent to the seizing pin 470 may be employed. The impedance matching may be within 10% or 20% or 25 % or 30% or 40%.

### Tap Hardline Seizing Mechanisms

Some embodiments employ selected ones of the tap hardline seizing mechanisms described below. FIG. 4C shows a seizing pin assembly 400C for use with the tap of FIG. 4B. The assembly includes a seizing pin 480, a contactor or ball 482, and a compression spring or loop spring such as an open loop spring, flattened loop spring, or flattened open loop spring 484. The assembled seizing pin at left 486 includes an elongated pin 487 affixed to a cage 488 with holes 482 for receiving the coaxial connector stinger 464. Below the ball is compression spring 484.

In various embodiments, the seizing pin 480 includes an elongated portion 487 and a cage 488 that may be one part or multiple interconnected parts providing electrical conductivity between a stinger 464 inserted in the cage and the elongated portion of seizing pin 480 which interconnects with tap terminal 472 which connects with tap electronics 230.

FIG. 4D shows a portion of a stinger seizing pin 400D. As seen, a seizing pin cage 488 includes a ball 482 biased by a spring 484, the ball for pressing the caged stinger against the cage or against the cage roof 489 such that the stinger 464 is electrically connected with the seizing pin. The spring may be a compression spring, may be in form of a loop, may be in the form of an open loop, or may be in the form of an open loop that is flattened such that the opening in the loop contacts the ball.

FIG. 4E shows a seizing pin similar to those of FIGS. 4A and 4C. A related x-y-z coordinate system shows that a coaxial cable connector may be installed from two directions (see e.g., 310, 311 and 320, 321). For example, a coaxial connector 495 may approach from the z direction and be inserted in a hole 493 that passes through the cage 488. For example, a coaxial connector 497 may approach from the x direction and be inserted in a hole 494 that passes through the cage 488. The approach direction chosen may depend upon the arrangement of coaxial cable with respect to the tap.

Extended frequency features of the tap hardline seizing mechanism may include elimination of a screwed connection, elimination of irregular conductor geometry, and reduction of conductor size.

### Tap Electronics with Hardline Inductor

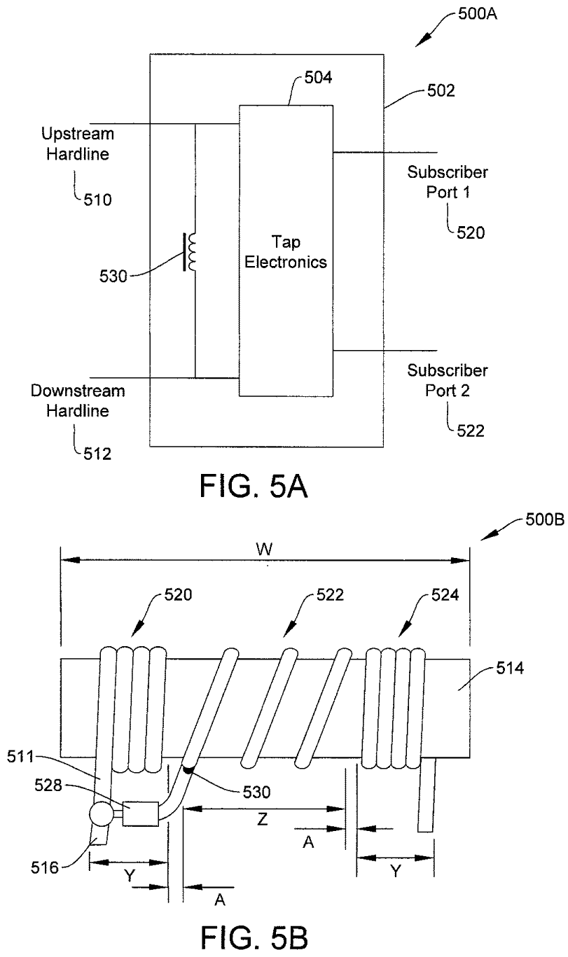

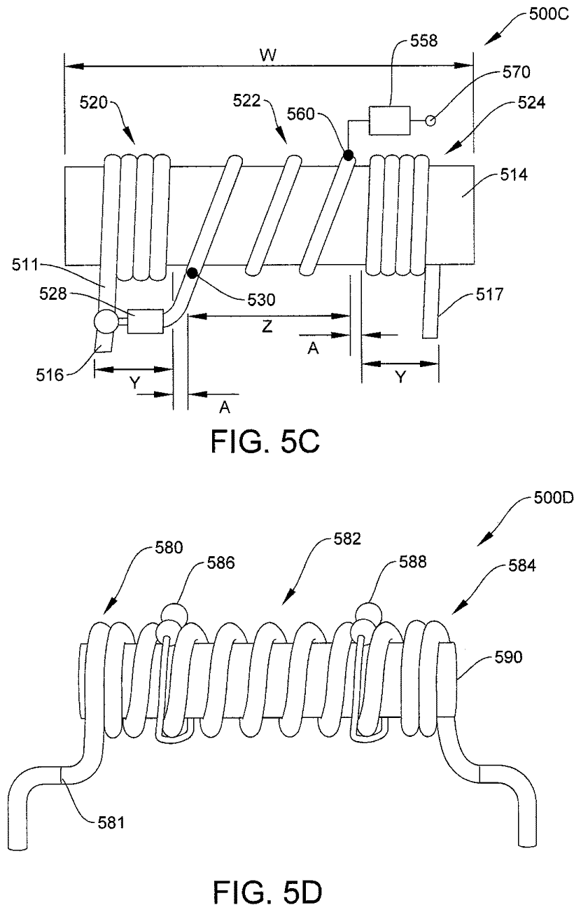

Various embodiments employ selected ones of the tap electronics features described below. FIG. 5A shows a tap similar to the ones described above 500A.

The tap includes a housing 502, tap electronics 504 and a hardline inductor 530.

Tap electronics 504 may be said to include the tap inductor 530. The tap electronics interconnect with a) upstream 510 and downstream 512 hardlines and with b) subscriber port 1, 520 and subscriber port 2, 522. Notably, additional subscriber ports may be included.

FIG. 5B shows a first wound inductor 500B. The inductor or choke 530 may take the form of the inductor shown in 500B. Here, the inductor has a core 514, a length W, and windings 520, 522, 524 from wire 511 coiled about the core. A resistor 528 from an inductor end connection 516 to an adjacent portion of a winding 530 dampens a resonance that absorbs RF energy at a certain frequency. Clustered turns 520, 524 form parallel resonant sections at each end of the coil and spread windings 522 in the center are intended to counteract the standing wave peaks along the coil.

FIG. 5C shows a second wound inductor 500C. The inductor or choke 530 may take the form of the inductor shown in 500C. Here, the inductor has a core 514, a length W, and windings 520, 522, 524 from wire 511 coiled about the core. A resistor 528 from an inductor end connection 516 to an adjacent portion of a winding 530 dampens a resonance that absorbs RF energy at a certain frequency. A second resistor similarly located at the opposite end of the of the inductor may interconnect with either of the inductor end connections. The second resistor may be in addition to the first resistor or in place of the first resistor. Clustered turns 520, 524 form parallel resonant sections at each end of the coil and spread windings 522 in the center are intended to counteract the standing wave peaks along the coil.

FIG. 5D shows a third wound inductor 500D. The inductor or choke 530 may take the form of the inductor shown in 500D. Here, the inductor has a core 590 and windings 580, 582, 584 from wire 581 coiled about the core. The windings may be similar to those described in FIG. 5B above. Collars 586 and 588 encircle the core between windings 580, 582 and between windings 582, 584. These collars may dampen resonance that absorbs RF energy at a particular frequency or range of frequencies.

The collars 586, 588 may be electrically resistive collars that do not interconnect with the windings 580, 582, 584. The collars may be configured as clips, each clip encircling all or a portion of the inductor 500D. The collars may be positioned between, alongside, or atop of the windings. In some embodiments, as shown, the collars may form an open loop with spheres at the ends of the loop. In other embodiments, the collars may take the form of multiple loops encircling the inductor which are open or not and which are terminated with spheres or not.

In various embodiments, collars may be made from materials including carbon and/or ceramic and/or mixtures thereof. Collars may be “leaded resistors.” Collars may contact or interconnect electrically or otherwise with the enameled wire or where enamel has been removed from the wire. The collars may have no electrical interconnection with the windings. In an embodiment, the collars do not make electrical contact with the windings due to insulation on the windings such as enamel insulation which is typical of wire wound inductors. In an embodiment, the inductor 500D is in the form of a collar encircling at least a portion or substantial portion of the inductor girth. In an embodiment, the collars do not make electrical contact for AC or DC current due to the insulation on the wires. In various embodiments, the collars dampen the electromagnetic fields created when RF and/or RF resonance occurs across the inductor or RF choke.

Extended frequency features of the various inductors 500B-D include dampening electromagnetic fields.

While various embodiments of the present invention have been described above, it should be understood that they are presented as examples only, and not as limitations. It will be apparent to those skilled in the art that changes in the form and details can be made without departing from the spirit and scope of the invention. As such, the breadth and scope of the present invention should not be limited by the above-described exemplary embodiments but should be defined only in accordance with the following claims and equivalents thereof.

1. A cable television tap with extended frequency features comprising:
a metallic tap housing with internal tap electronics;
the housing having upstream and downstream sockets for receiving stingers of respective upstream and downstream coaxial cable connectors that terminate upstream and downstream hardline coaxial cables;
a first of the sockets leading to an outer passage that is adjacent to an inner passage; and,
a first of the stingers inserted through centers of the passages and thereafter through a seizing pin cage;
wherein the first stinger passes coaxially through the inner passage with an impedance that is within 30% of the impedance of the upstream hardline coaxial cables.

2. The cable television tap of claim 1 wherein the passages are adjoining passages.

3. The cable television tap of claim 1 wherein the inner passage is smaller than the outer passage.

4. The cable television tap of claim 1 wherein the inner and outer passages are circular.

5. The cable television tap of claim 1 wherein between the cage and the inner passage the stinger passes through a shielding member hole that is smaller than the inner passage.

6. The cable television tap of claim 1 wherein the shielding member hole is sized such the stinger passing therethrough substantially closes the hole and attenuates radio frequency signals passing therethrough.

7. The cable television tap of claim 1 wherein the seizing pin bears on a tap terminal that provides an interconnection with tap electronics.

8. A cable television tap with extended frequency features comprising:
a metallic tap housing with internal tap electronics;
the housing having upstream and downstream sockets for receiving stingers of respective upstream and downstream coaxial cable connectors that terminate upstream and downstream hardline coaxial cables;
a first of the sockets having a circular outer passage interconnecting with a circular inner passage;
a first of the stingers inserted through the centers of the passages and thereafter through a hole in a seizing pin cage; and,
a seizing pin cage and a caged ball below the stinger;
wherein the ball is urged toward a cage roof by a compression spring formed from a flattened open metallic loop, the opening in the loop or the opening ends bearing on the ball and the ball contacting the stinger.

9. The cable television tap of claim 8 wherein the outer passage diameter is smaller than the upstream coaxial hardline cable diameter.

10. The cable television tap of claim 8 wherein the outer passage diameter is 70 to 85 percent of the upstream coaxial hardline cable diameter.

11. The cable television tap of claim 8 wherein the inner and outer passage diameters are smaller than the socket diameter.

12. The cable television tap of claim 8 wherein the inner passage diameter is less than half of the socket diameter.

13. The cable television tap of claim 8 further including:
the stinger of the upstream coaxial cable connector and a seizing pin;
wherein a 75 ohm impedance of the downstream hardline coaxial cable matches within 25% the impedance of the stinger as it passes between the seizing pin and the upstream coaxial cable connector.

14. A cable television tap with extended frequency features comprising:
a metallic tap housing with internal tap electronics;
the housing having upstream and downstream sockets for receiving stingers of respective upstream and downstream coaxial cable connectors that terminate upstream and downstream hardline coaxial cables;
an inductor including wire encircling a magnetic core such that there are at least 1^{st}, 2^{nd}, and 3^{rd} windings, the 2^{nd} winding being between the 1^{st} and 3^{rd} windings;
the inductor interconnecting center conductors of the upstream and downstream hardline coaxial cables; and,
electrically resistive collars that do not interconnect with the windings encircling the inductor near a boundary between a 1^{st} and 2^{nd} winding and near a boundary between a 2^{nd} and 3^{rd} winding;
wherein the collars dampen electromagnetic fields created when RF resonance occurs across the inductor.

15. The cable television tap of claim 14 wherein between the cage and the inner passage the stinger passes through a shielding member hole that is smaller than the inner passage.

16. The cable television tap of claim 14 wherein the shielding member hole is sized such that insertion of the stinger substantially attenuates radio frequency signals passing therethrough.

17. The cable television tap of claim 14 wherein the seizing pin bears on a tap terminal and provides an interconnection with tap electronics.

18. The cable television tap of claim 14 wherein the outer passage diameter is 70 to 85 percent of the upstream coaxial hardline cable diameter.

19. The cable television tap of claim 14 wherein the inner passage diameter is less than half of the socket diameter.

20. The cable television tap of claim 14 further including:
the stinger of the upstream coaxial cable connector and a seizing pin;
wherein a 75 ohm impedance of the downstream hardline coaxial cable matches within 25% the impedance of the stinger as it passes between the seizing pin and the downstream coaxial cable connector.
